(19) United States
(12) Patent Application Publication
(10) Pub. No.: US 2004/0179837 A1
(43) Pub. Date: Sep. 16, 2004

(54) Method and arrangement for the determination and separation of single-channel effects on the optical transmission of a wavelength division multiplex (WDM) signal

(76) Inventors: Harald Bock, Leutenbach (DE); Jorg-Peter Elbers, Munchen (DE); Andreas Farbert, Munchen (DE); Christian Scheerer, Ottawa (CA)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/752,377

(22) Filed: Jan. 5, 2004

(30) Foreign Application Priority Data
Jul. 5, 2001 (DE) 10132584.3
Jul. 5, 2002 (WO) PCT/DE02/02473

(51) Int. Cl. H04B 10/08

(52) U.S. Cl. 398/25

(57) ABSTRACT

A method and arrangement for the determination and separation of single channel effects “Group Velocity Dispersion” (GVD), “Self Phase Modulation” (SPM), “Intra Channel Cross-talk” (ICC) and “Stimulated Brillouin Scattering” (SBS) on optical transmission of a wavelength multiplex (WDM) signal which comprises several channels are disclosed. The channels are separated by a demultiplexer and fed to an electrooptical converter for the generation of electrical signals. The electrical signals comprising broadband frequency data contain distortions due to the single channel effects on optical transmission. The electrical signals are supplied to an electrical spectrum analyser and an electrical amplitude distributor for the analysis, determination and separation of the single channel effects.

The invention relates to a method and an arrangement for the determination and separation of single-channel effects on optical transmission of a Wavelength Division Multiplex (WDM) signal.

Non-linear faults occur during the transmission of WDM signals by optical fibers. On the one hand the multichannel interference effects manifest themselves as increased noise on the signal levels of all or a number of channels, on the other hand channel signals exhibit deterministic distortions through individual effects. With an optical transmission systems these noise effects must be determined and subsequently minimized. For this purpose methods for measuring the quality characteristics of a transmitted signal, for example by determining the Q factor or the bit error rate or the number of corrected bits by means of a Forward Error Correction (FEC) module are known (see “Optical Fiber Communications”, IIIA, f. P. Kaminow, T. L. Koch, 1997, p. 316).

There are two different effects which are decisive factors for non-linear faults causing interference between the channels, so-called multichannel interference in the transmission of wavelength division multiplex (WDM) systems over optical fibers. One of these is the Kerr effect and the other the non-linear scattering process. The Kerr effect mainly causes four wave mixing (FWM) and/or cross chase modulation (XPM). The non-linear scattering process causes stimulated raman scattering (SRS). These non-linear effects are fully described in “Fiber-Optic Communication Systems”, G. P. Agrawal, 2nd Edition, 1997, pp. 323-328. These multichannel interactions will occur especially with “Dense-Wavelength-Division-Multiplex” (DWDM) transmission since with these systems the channel spacings are even narrower than with WDM systems. For optimum transmission these effects must be measured and minimized so that the Q factor exhibits as high as possible a constant value for all channels. The old Patent Application

DE 10110270.4 contains a detailed description of a method of this type for determining and distinguishing multichannel interference, especially those caused by Kerr effects and scatter processes on transmission of a WDM signal.

As described above, a quality measurement originating from amplitude histograms does not supply sufficient information to determine and distinguish between single-channel effects, especially from Group Velocity Dispersion (GVD), Self Phase Modulation (SPM), Intra channel crosstalk (ICC) and Stimulated Brillouin Scattering (SBS).

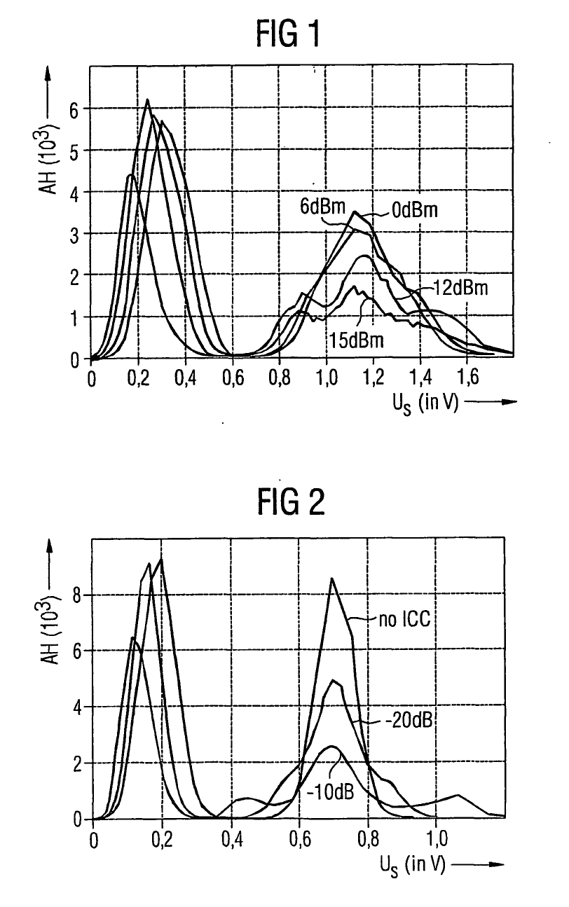

As an example of these deficiencies, FIGS. 1 and 2 show two amplitude histograms of a channel with GVD and/or SPM effects or with the ICC effect. The figures show:

FIG. 1: Amplitude histograms at different channel power with full dispersion compensation,

FIG. 2: Amplitude histograms for different crosstalk within a wavelength.

The amplitude histogram AH shown in FIG. 1 was created for different channel powers of 0, 6, 12, 15 dBm after 50 km of a standard single-mode fiber with full dispersion compensation e.g. by means of a Dispersion Compensating Fiber (DCF) fiber. In this case a synchronous sampling of a binary channel signal by means of a variable sampling voltage US was used. The drawing shows that the single-channel effect GVD is fully compensated for by the DCF fiber, so that no signal distortions of a channel are to be established provided the channel power is low and thus SPM is not making any contribution. With high channel power on the other hand, as a result of the increasing occurrence of SPM, a number of peaks or troughs occur in the amplitude distribution of the “1” level of a channel. This can be used as a criterion in order to determine a non-optimized dispersion compensation between GVD and SPM.

FIG. 2 shows the amplitude histogram AH for a channel, e.g. at the output of an optical ADD/DROP multiplexer, for different signal levels of the crosstalk ICC (−10, −20 dB and without ICC) in a channel. It can clearly be seen here that the amplitude histogram obtained is practically identical to that shown in FIG. 1

Both amplitude histograms of FIGS. 1 and 2 deviate from the optimum gaussian distribution type transmission without GVD/SPM or without ICC of the “0” and “1” channel values of so-called levels in the same way. This thus does not make possible any separation between the GVD/SPM single-channel effects occurring on one side and the ICC effects on the other side. The similar influence of these single-channel effects on the amplitude histogram has also already been pointed out in “Histogram method for performance monitoring of the optical channel', C. M. Meinert, Heinrich-Hertz-Institut for Nachrichtentechnik Berlin GmbH, p.121-122.

Furthermore methods are known which guarantee a compensation between dispersion GVD and Self Phase Modulation SPM. Thus for example a method and an arrangement for reducing SPM and GVD is known from EP 0 963 066 A1. Above and beyond this, the old Application “Arrangement and method for optimizing the signal quality of a WDM signal exhibiting residual dispersion in an optical transmission system^{o}, registration date Jun. 6, 2001, from the applicant proposed a method for determining and compensating for dispersion GVD, SPM and XPM effects for optimization of the signal quality of a transmitted optical WDM signal. In this earlier application a method was indicated for determining and separating the individual effects GVD and SPM, but not however for the further individual effects ICC and SBS.

The object of the present invention is now to determine and to separate single-channel effects GVD, SPM, ICC and SBS which occur during the optical transmission of wavelength multiplex signals.

In accordance with the invention this object is achieved by a method and an arrangement in accordance with the features of claims 1 and 5.

Useful further developments are described in the dependent claims.

The method in accordance with the invention for determining and separating single-channel effects GVD, SPM, ICC and SBS on optical transmission of a wavelength division multiplex (WDM) signal for which the channels are separated and converted into electrical signals is based on the analysis of the amplitude histogram and the spectrum diagram for each electrical signal.

Whereas the signals of a channel are binary coded for transmission at two levels—(0) and (1)—the corresponding converted electrical signal is provided as an analog signal. The amplitude histogram is determined as a probability density distribution of the amplitudes of the electrical signal, in which case the two levels (0) and (1) are provided as individual peaks in the amplitude histogram with optimum transmission or with different signal to noise ratios of a channel. The single-channel effects dispersion and self phase modulation GVD/SPM, especially with high channel powers, or crosstalk ICC, will be determined by more than two peaks or troughs in the amplitude histogram.

The spectrum diagram is also determined as a power density spectrum of the electrical signal in which case a number of frequencies from transmitted data of the electrical signal are shown over a corresponding data bandwidth in the spectrum diagram. With low channel powers in particular the single-channel effect dispersion GVD is determined by at least one minimum within and above the data bandwidth in the spectrum diagram. Likewise, with high channel powers in particular the single-channel effect self phase modulation SPM is determined by at least one minimum within the data bandwidth in the spectrum diagram. The effects GVD and SPM can thus be determined and compensated for in an advantageous way.

By contrast with GVD/SPM, the spectrum diagram remains unchanged with the occurrence of crosstalk ICC. Thus the single-channel effect ICC can be determined by observing the previously obtained amplitude histogram in connection with the corresponding spectrum diagram and be separated from the other single-channel effects GVD/SPM.

Finally the single-channel effect SBS (Stimulated Brillouin Scattering) is determined by a weakening of the channels in the lower frequency area (below appr. 100 MHz) in the spectrum diagram of the method in accordance with the invention. This effect does not occur for the previously determined single-channel effects GVD, SPM and ICC. The amplitude histogram can also be used to measure the quality of the transmission which outputs a quality parameter such as the Q factor, the bit error rate or the eye opening of a signal. For low frequencies of the transmitted data of the electrical signal the performance density falls in the electrical spectrum. This attenuation of the carrier with SBS also reduces the signal quality, i.e. the Q factor typically falls.

An exemplary embodiment of the invention is described in more detail on the basis of the drawing. The figures show:

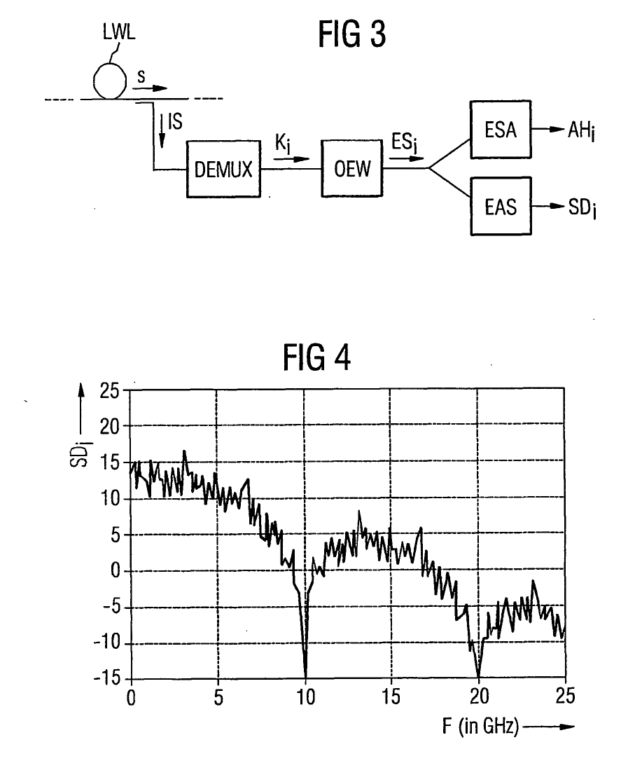

FIG. 3: The arrangement in accordance with the invention,

FIG. 4: the electrical spectrum diagram for different pulse shapes of the NRZ data signal,

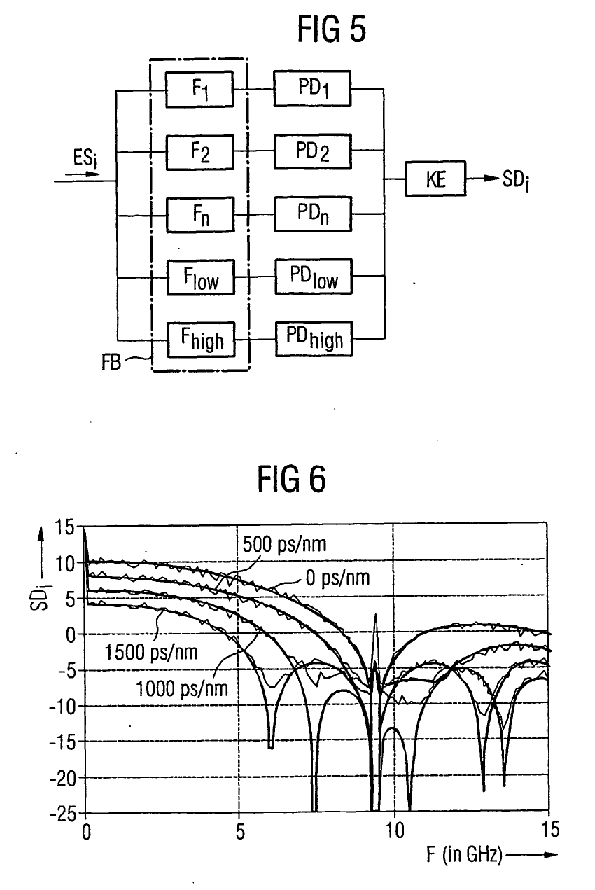

FIG. 5: the electrical spectrum analyzer,

FIG. 6: The electrical spectrum diagram for different dispersion values with linear propagation,

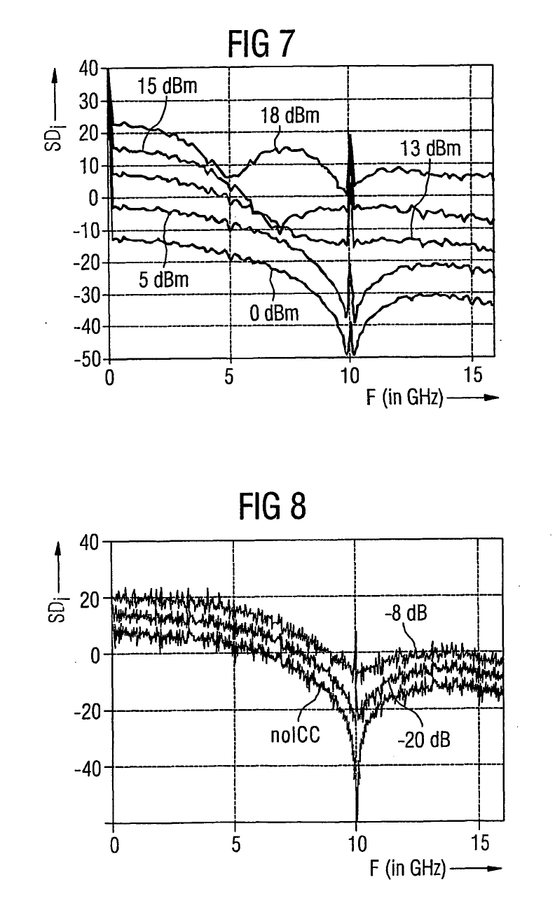

FIG. 7: The electrical spectrum diagrams with complete dispersion compensation with different channel powers,

FIG. 8: the electrical spectrum diagram with different crosstalk values ICC,

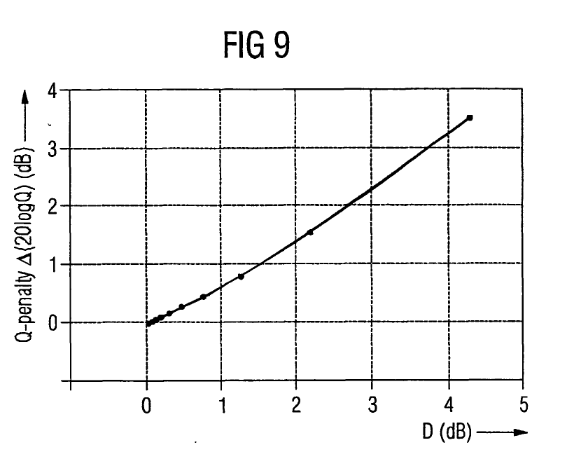

FIG. 9: the deterioration of the transmission quality with SBS.

In FIG. 3 the arrangement in accordance with the invention is shown schematically. At least one part of a WDM signal S uncoupled from a fiber optic link is fed to the input of the arrangement as an input signal IS. The input signal IS is routed to a demultiplexer DEMUX, for example a spectrally tunable optical filter, for separating its channels K_{I} (I>0). At least one channel K_{I} is further converted by a opto-electrical converter OEW, e.g. a photodiode, into an analog electrical signal ES_{I}. The electrical signal ES_{I} is routed on one side to an electrical amplitude distributor EAS and on the other side to an electrical spectrum analyzer ESA.

In the electrical amplitude distributor EAS synchronous sampling is used to create an amplitude histogram AHᵢ of the electrical signal ES_{I}. FIGS. 1 and 2 shown these types of amplitude histograms AHi. On the basis of this amplitude histogram AH_{I} a further measurement of the Q factor Q, the bit error rate BER or the eye opening of the data transmitted by the electrical signal ES_{I} is used to estimate the transmission quality of a channel K_{I}. Other methods are possible for measuring the quality of the channel but are not mentioned further here.

The amplitude histogram AH_{I} makes it possible to determine the single-channel effects GVD, SPM and ICC, however the separation between GVD/SPM and ICC single-channel effects cannot be implemented.

The electrical Spectrum analyzer ESA delivers a broadband spectrum diagram SD_{I} of the electrical signal ES_{I} with binary codes and broadband data DS_{I}. Spectrum diagram SD_{I} determines and shows all the selected frequencies of the data DSi. The data DSᵢ is usually binary coded on two levels “0” and “1” and modulated in a data bandwidth modulated by the carrier frequency.

FIG. 4 shows electrical spectrum diagrams SD_{I} in frequency range F for two different pulse shapes created by a simulation—formed with cosine squared edges deformed in power (solid curve) or in amplitude (dotted curve)—of a non-return-to-zero (NRZ) data signal with a data rate of 10 Gbit/s. The data DSᵢ is generated as a pseudo random bit stream (PRBS=2³¹−1) for this simulation, so that a data bandwidth up to appr. maximum 10 GHz (or appr. 7 GHz in practice) is used for data transmission. The pulse shape has a strong influence on the sidelines at 10, 20 GHz and higher orders of the carrier frequency, but hardly influences the curve of the spectrum of the data DSi in the data bandwidth at all. To determine the single-channel effects the complete spectrum outside the sidelines can thus be used. Deviations from the expected shape allow conclusions to be drawn about signal distortions and will also not be caused by small fluctuations of the senders.

FIG. 5 shows a schematic diagram of the electrical spectrum analyzer ESA for analysis of the electrical signal ES_{I}. No high-resolution electrical spectrum analysis is undertaken as this is normally achieved in laboratory devices by a frequency mixer. With the invention electrical filters F₁, . . . ,Fₙ, F_{low}, F_{high} are used, into which the electrical signal ES_{I} is injected. Power detectors PD₂, . . . ,PDₙ, PD_{low}, PD_{high} are connected downstream from electrical filters F₁, . . . ,Fₙ, F_{low}, F_{high} and issue spectral components of the electrical signal SEi to a control unit KE for creation of the spectrum diagram SD_{I}. In this case the electrical spectrum is roughly resolved and determined by the bank of filters FB featuring filters F₁, . . . , Fₙ, F_{low}, F_{high}. This parallel arrangement offers high speed and an improvement of around 10 dB in the signal-to-noise ratio compared to a frequency mixer. This arrangement also allows simple integration of the arrangement shown in FIG. 3.

FIG. 6 shows electrical spectrum diagrams SD_{I} below and above the first 10 GHz side line for different dispersion values (0, 500, 1000, 1500 ps/nm) with linear propagation, i.e. with low channel powers of with so-called small signal approximation. The dispersion GVD and the self phase modulation SPM are expressed as a change in the received spectrum diagram SD_{I} as an electrical power density spectrum in relation to the output signal of an optical fiber This effect can be analytically described by the fiber transmission function, especially with small signal approximation. This effect is known from “Small Signal analysis for Dispersive optical Fiber Communication Systems”, Jiammin Wang, Klaus Petermann, Journal of Lightwave Technology, Vol. 10, No. 1, January 1992, pp. 96-99.

The curves shown in FIG. 6 are displaced vertically to improve clarity. The dotted line shown corresponds to the numerical simulation with the electrical signal ES_{I} used In FIG. 4 and the solid line to the analytical calculation with small signal approximation. Increasing the dispersion GVD (0 to 1500 ps/mm) forms troughs which fully tally between the numerical simulation and analytical calculation. At the location of these troughs the data DSi of the corresponding frequencies will be harder to transmit or not able to be transmitted at all. The depths of the troughs depend on the discretization of electrical signal ES_{I} in the numerical simulation. By comparing the numerical simulation and the analytical calculation the dispersion GVD can thus be read off directly as accumulated residual dispersion in channel K_{I} with small channel powers. In addition this is usable information for a further dispersion compensation.

FIG. 7 shows the spectrum diagrams SD_{I} from FIG. 6, but with increasing to high channel powers and with complete dispersion compensation. for the numerical simulation of the interaction between SPM and GVD effects on the basis of the analytical calculation shown a corresponding non-linear expansion of the fiber transmission function is undertaken. The curves for different channel powers 0, 5, 13, 15, 18 dBm are shifted vertically to show them more clearly. The optical fiber used for the simulation is a 100 km long standard single-mode fiber with an additional 21.5 km long dispersion compensation fiber DCF. for increasing channel power the spectrum diagram becomes ever flatter and, especially with high channel powers, exhibits a minimum below the first 10 GHz side line which reduces the usable data bandwidth. Above the 10 GHz side line the spectrum diagram also becomes flatter as the channel power increases.

Thus single-channel effects dispersion GVD and self phase modulation SPM are determined at low and high channel power by level splitting through occurrence of troughs or deformation of the spectrum diagram SD_{I}. No distinction need be made between the two single channel effects GVD and SPM since the two effects work in opposite ways. When these effects occur an attempt is made to achieve adequate balance between the two effects to improve the data quality in the desired data bandwidth.

FIG. 8 shows electrical spectrum diagrams for different crosstalk values ICC (no ICC, −20 dB, −8 dB) in a channel K_{I} by a numerical simulation. The curves are displaced vertically to show them more clearly. It should be stressed that, unlike GVD and SPM, the single-channel effect ICC does not affect the spectrum diagram SD_{I}. In combination with the previous influences on the amplitude histogram AHi, in which all single-channel effects GVD, SPM and ICC are determined with the same effect, the spectrum histogram SD_{I} for which the crosstalk ICC in a channel will not be determined thus supplies a means of separating the crosstalk ICC from GVD and SPM single-channel effects.

FIG. 9 shows the deterioration of the transmission quality with Stimulated Brillouin Scattering SBS. The deviation of the Q factor, known as the Q penaltyΔ(20 log Q ) as a function of the attenuation D of the carrier, is shown as a suitable measures for determining SBS in a channel. The Q factor can be determined directly from the amplitude histogram AHᵢ. The Q Penalty increases as SBS causes attenuation to rise in the carrier. This can also be detected by narrower eye opening, especially for low frequencies of data DS_{I} below around 100 MHz. Therefore the spectrum diagram SD_{I} will show a weakening of the lowest frequency with the single-channel effect SBS. Thus the single-channel effect SBS can be determined and furthermore separated from the other single-channel effects GVD, SPM and ICC.

The method in accordance with the invention can be executed on an already installed WDM transmission system during operation or during installation. Integration into a DWDM system and thereby into these regulation concepts is likewise possible. In future systems this invention offers a regulation of adaptive dispersion or PMD compensation.

1. Method for determination of single-channel effects for the optical transmission of a wavelength division multiplex (WDM) signal (S), of which the channels (K_{I}) (I>0) are separated and converted into electrical signals (ES_{I}),
characterized in that,
dispersion (GVD) and/or Self Phase Modulation (SPM) and/or Crosstalk (ICC) and/or Stimulated Brillouin Scattering (SBS) are identified as single-channel effects in optical transmission,
that an amplitude histogram (AH_{I}) and a spectrum diagram (SD_{I}) of the corresponding electrical signal (ES_{I}) will be determined from at least one 1 channel (K_{I}),
and finally by an analysis of the amplitude histogram (AH_{I}) and of the spectrum diagram (SD_{I}) each of the single-channel effects (GVD/SPM, ICC, SBS) will be determined separately.

2. Method according to claim 1,
characterized in that,
a data signal (DS_{I}) of the channel (K_{I}) will be transmitted binary coded on two levels (0) and (1),
the data signals (DS_{I}) will be converted by digital/analog conversion into the electrical signal (ES_{I}),
the amplitude histogram (AH_{I}) will be determined as a probability density distribution of the amplitudes of the electrical signal (ES_{I}), with the two levels (0) and (1) being provided as individual peaks in the amplitude histogram(AHi) for optimum transmission or for different signal-to-noise ratios (OSNR) of a channel (K_{I}), and single-channel effects (GVD/SPM) or (ICC) will be determined by more than two peaks or troughs in the amplitude histogram (AH_{I}) with high channel powers.

3. Method according to claim 1 or 2,
characterized in that,
the spectrum diagram (SD_{I}) is determined as a power density spectrum of the electrical signal (ES_{I}) in which case broadband frequencies of transmitted data signals (DS_{I}) of electrical signal (ES_{I}) are shown within a corresponding data bandwidth in the spectrum diagram (SD_{I}), especially with low channel powers the single-channel effect dispersion (GVD) and/or, especially with high channel powers the single-channel effect Self Phase Modulation (SPM) will be determined by at least one trough within the data bandwidth in the spectrum diagram (SD_{I}) and the spectrum diagram (SD_{I}) remains unchanged with the occurrence of crosstalk (ICC).

4. Method according to claim 1 or 2,
characterized in that,
the spectrum diagram (SD_{I}) is determined as a power density spectrum of the electrical signal (ES_{I}) in which case broadband frequencies of transmitted data signals (DS_{I}) of electrical signal (ES_{I}) are shown within and above a corresponding data bandwidth in the spectrum diagram (SD_{I}),
especially with low channel powers. the single-channel effect (GVD) will be determined by at least one trough within and above the data bandwidth in the spectrum diagram (SD_{I}),
especially with high channel powers, the single-channel effect (SPM) will be determined by at least one trough within the data bandwidth in the spectrum diagram (SD_{I}), and
the spectrum diagram (SD_{I}) remains unchanged with the occurrence of crosstalk (ICC).

5. Method according to one of the previous claims, characterized in that,
Stimulated Brillouin Scattering (SBS) will be determined by a weakening of the channels in the low frequency area below appr. 100 MHz in the spectrum diagram (SD_{I}) or,
a quality parameter (Q_{I}) will be calculated from the amplitude histogram (AH_{I}) for each channel (K_{I}) and determined as Q factor (Q) and
Stimulated Brillouin Scattering (SBS) will be determined by a high Q-Penalty of the Q factor (Q).

6. Arrangement for determining of single-channel effects in the optical transmission of a wavelength division multiplex (WDM) signal (S), of which the channels (K_{I}) (I>0) will be separated by a demultiplexer (DEMUX) and fed into an electro-optical converter (EOW) to create electrical signals (ES_{I}),
characterized in that,
the electrical signals (ES_{I}) for establishing and separating of single-channel effects caused by dispersion (GVD) and/or Self Phase Modulation (SPM) and/or crosstalk (ICC) and/or Stimulated Brillouin Scattering (SBS) are routed during optical transmission to an electrical spectrum analyzer (ESA) and an electrical amplitude distributor (EAS) in each case.

7. Arrangement according to claim 6, characterized in that, the channels (K_{I}) feature digital or binary-coded data signals (DS_{I}), the electrical signals (ES_{I}) originating form the channels (K_{I}) are provided as analog signals and
the electrical amplitude distributor (EAS) features a module (AM) for creation of an amplitude histogram (AH_{I}) of the electrical signals (ES_{I})

8. Arrangement according to claim 6 or 7,
characterized in that,
the electrical signal (ES_{I}) features data signals (DS_{I}) that will be transmitted within a data bandwidth and
the electrical spectrum analyzer (ESA) features a number of electrical filters (Fk) (k>0) switched in parallel for spectral separation of the data signals (DS_{I},) within the bandwidth and for spectral recording of frequencies above the data bandwidth and that a module (SM) for creation of a spectrum diagram (SDᵢ) for each electrical signal (ESᵢ) is connected dowstream of the electrical filters (Fₖ).
